(19) United States
(12) Patent Application Publication
(10) Pub. No.: US 2019/0164097 A1
(43) Pub. Date: May 30, 2019

(54) METHOD AND SYSTEM TO CONDUCT AN AUDIT FOR CONTROLLING QUALITY OF A FACILITY

(71) Applicant: Ruptub Solutions Private Limited, Karnataka (IN)

(72) Inventors: Sidharth Gupta, Bangalore (IN); Kadam Jeet Jain, Bangalore (IN); Rahul Chaudhary, Bangalore (IN); Punit Garg, Bangalore (IN); Khilan Haria, Bangalore (IN); Ankita Gandhi, Agra (IN); Vidit Sinha, Bangalore (IN); Rajdeep Singh, Karnataka (IN); Abhishek Nair, Mumbai (IN); Shashank Rao, Bangalore (IN); Shubhangi Agarwal, Lucknow (IN); Abhishek Malani, Hyderabad (IN); Raghavendra Reddy, ANDHRA PRADESH (IN); Ribin Paikattu Kavil, Bangalore (IN); Rahul Boggaram Nagarjuna Gupta, Bangalore (IN)

(21) Appl. No.: 15/897,451

(22) Filed: Feb. 15, 2018

(30) Foreign Application Priority Data
Nov. 25, 2017 (IN) 201741042320

(51) Int. Cl. G06Q 10/06; G06N 99/00

(52) U.S. Cl. CPC G06Q 10/06311; G06N 99/005

(57) ABSTRACT

A method and system to conduct an audit for control and maintain the quality of a digital facility. The system executes instructions to causes one or more processors to perform a method. The method includes a first step of collecting a first set of data and a second step of creating one or more tasks. The method includes a third step of receiving a second set of data. The method includes a fourth step of analyzing the first set of data and the second set of data and a fifth step of assigning the one or more tasks. The method includes a sixth step of obtaining the third set of data. The method includes a seventh step of determining the deviation in the first set of data and the third set of data and an eighth step of rating a plurality of auditors.

### CROSS-REFERENCES TO RELATED APPLICATION

The present application claims the benefit under 35 U.S.C. § 119(e) of the filing date of India Patent Application Serial No. 201741042320 for SYSTEM TO CONDUCT AN AUDIT FOR CONTROLLING QUALITY OF A FACILITY, filed Nov. 25, 2017, which is hereby incorporated by reference in its entirety for all purposes.

### TECHNICAL FIELD

The present disclosure relates to a field of facility management system. More particular, the present disclosure relates to a method and system for conducting an audit to control the quality of the digital facility.

### BACKGROUND

Service industry has taken a major leap with the huge increase in number of people constantly travelling from one place to another. People are in constant need for a place to stay overnight or for a few days. Typically, people stay in various hotels which match their needs and comfort ability factor. These hotels have been operating in an automated fashion since very long. Nowadays, there are innumerable software systems for managing hotel operations in real time. Further, these hotels continuously try to evolve and understand their customer needs in order to be more efficient. Maintenance of quality of the hotels is a big task for hotel owners. In addition, managing the quality of the facility needs time and money. Managing quality of the facility includes a regular audit of the facility, solving multiple major issues related to the facility and monitoring a large number of tasks related to the audit. The audit of the facility is done in multiple ways. The audit of the facility may be based on pen paper or may be computing device based audit. The audit of the multiple facilities in a short interval of time creates a lot of data which is not an easy task for a facility management team to handle. Existing facility management systems do not conduct the audit for each region of the facility in an efficient way. This has led to a demand for a facility management system for the audit of each region of the multiple regions of the facility to control the quality of the audit.

### SUMMARY

In a first example, a computer-implemented method is provided. The computer-implemented method is configured to conduct an audit for controlling the quality of a digital facility based on the feedback collected from a plurality of sources. The computer-implemented method may include a first step of collecting a first set of data associated with the feedback of the digital facility. In addition, the computer-implemented method may include a second step of creating one or more tasks corresponding to the audit of the digital facility. Further, the computer-implemented method may include a third step of receiving a second set of data associated with a plurality of auditors. Furthermore, the computer-implemented method may include a fourth step of analyzing the first set of data and the second set of data using machine learning algorithms to identify the competent auditor for the one or more tasks. Moreover, the computer-implemented method may include a fifth step of assigning the one or more tasks to each of the plurality of auditors for the audit of the digital facility. Also, the computer-implemented method may include a sixth step of obtaining the third set of data associated with the audit of the digital facility from the plurality of auditors. The computer-implemented method may include a seventh step of determining the deviation in the first set of data and the third set of data. In addition, the computer-implemented method may include an eighth step of rating the plurality of auditors based on the key responsibility area. The feedback of the digital facility may be collected based on a plurality of micro descriptors associated with one or more regions of the digital facility. The first set of data may be collected from the plurality of sources. The one or more tasks may be created based on the first set of data. The plurality of auditors may conduct an audit of the digital facility based on the first set of data. The second set of data may be received in real time. The first set of data and the second set of data may be analyzed in real time. The one or more tasks may be assigned based on the analysis of the first set of data and the second set of data. The one or more tasks may be assigned in real time. The third set of data may be obtained in real time. The deviation in the first set of data and the second set of data may be used to identify one or more issues associated with the digital facility. The one or more issues may include high severity issues and not caught issues. The deviation may be determined in real time. The key responsibility area may be defined based on the status of the one or more tasks.

In an embodiment of the present disclosure, the computer-implemented method may perform yet another step of predicting the one or more issues associated with the digital facility and the time to resolve the one or more issues using machine learning algorithms. The machine learning algorithms are based on the past stored data and the real-time data of the digital facility.

In an embodiment of the present disclosure, the computer-implemented method may perform yet another step of storing the first set of data, the second set of data and the inspection data. The storing is done in real time.

In an embodiment of the present disclosure, the computer-implemented method may perform yet another step of updating the first set of data, the second set of data and the inspection data. The updating is done in real time.

In an embodiment of the present disclosure, the plurality of sources include quality assurance managers, visitors, feedback calls, secret auditor, feedback tab, crowdsource, manpower associated with the digital facility and one or more sensors associated with the digital facility.

In an embodiment of the present disclosure, the issue not caught is identified based on the one or more parameters. The one or more parameters include completion time of the one or more tasks, the status of the one or more tasks and quality of the audit.

In an embodiment of the present disclosure, the second set of data includes the profile of each auditor of the plurality of auditors, the experience of each auditor in audit field and demographic information of each auditor of the plurality of auditors. In an embodiment of the present disclosure, the computer-implemented method may perform yet another step of scheduling the one or more tasks for future audit of the digital facility. The scheduling of the one or more tasks is based on the one or more parameters. The one or more parameters include last audit data, one or more issues, date and time of the last audit.

In an embodiment of the present disclosure, the computer-implemented method may perform yet another step of alerting the plurality of auditors about the upcoming task and one or more unsolved issues.

In an embodiment of the present disclosure, the computer-implemented method may perform yet another step of arranging a quick inspection of the digital facility allocated to a guest. The quick inspection is arranged based on the check-in date and time of the guest.

In a second example, a computer system is provided. The computer system may include one or more processors and a memory coupled to the one or more processors. The memory may store instructions which, when executed by the one or more processors, may cause the one or more processors to perform a method. The method is configured to conduct an audit for controlling the quality of a digital facility based on the feedback collected from a plurality of sources. The method may include a first step of collecting a first set of data associated with the feedback of the digital facility. In addition, the method may include a second step of creating one or more tasks corresponding to the audit of the digital facility. Further, the method may include a third step of receiving a second set of data associated with a plurality of auditors. Furthermore, the method may include a fourth step of analyzing the first set of data and the second set of data using machine learning algorithms to identify the competent auditor for the one or more tasks. Moreover, the method may include a fifth step of assigning the one or more tasks to each of the plurality of auditors for the audit of the digital facility. Also, the method may include a sixth step of obtaining the third set of data associated with the audit of the digital facility from the plurality of auditors. The method may include a seventh step of determining the deviation in the first set of data and the third set of data. In addition, the method may include an eighth step of rating the plurality of auditors based on the key responsibility area. The feedback of the digital facility may be collected based on a plurality of micro descriptors associated with one or more regions of the digital facility. The first set of data may be collected from the plurality of sources. The one or more tasks may be created based on the first set of data. The plurality of auditors may conduct an audit of the digital facility based on the first set of data. The second set of data may be received in real time. The first set of data and the second set of data may be analyzed in real time. The one or more tasks may be assigned based on the analysis of the first set of data and the second set of data. The one or more tasks may be assigned in real time. The third set of data may be obtained in real time. The deviation in the first set of data and the second set of data may be used to identify one or more issues associated with the digital facility. The one or more issues may include high severity issues and not caught issues. The deviation may be determined in real time. The key responsibility area may be defined based on the status of the one or more tasks.

In a third example, a computer-readable storage medium is provided. The computer-readable storage medium encodes computer executable instructions that, when executed by at least one processor, performs a method. The method is configured to conduct an audit for controlling the quality of a digital facility based on the feedback collected from a plurality of sources. The method may include a first step of collecting a first set of data associated with the feedback of the digital facility. In addition, the method may include a second step of creating one or more tasks corresponding to the audit of the digital facility. Further, the method may include a third step of receiving a second set of data associated with a plurality of auditors. Furthermore, the method may include a fourth step of analyzing the first set of data and the second set of data using machine learning algorithms to identify the competent auditor for the one or more tasks. Moreover, the method may include a fifth step of assigning the one or more tasks to each of the plurality of auditors for the audit of the digital facility. Also, the method may include a sixth step of obtaining the third set of data associated with the audit of the digital facility from the plurality of auditors. The method may include a seventh step of determining the deviation in the first set of data and the third set of data. In addition, the method may include an eighth step of rating the plurality of auditors based on the key responsibility area. The feedback of the digital facility may be collected based on a plurality of micro descriptors associated with one or more regions of the digital facility. The first set of data may be collected from the plurality of sources. The one or more tasks may be created based on the first set of data. The plurality of auditors may conduct an audit of the digital facility based on the first set of data. The second set of data may be received in real time. The first set of data and the second set of data may be analyzed in real time. The one or more tasks may be assigned based on the analysis of the first set of data and the second set of data. The one or more tasks may be assigned in real time. The third set of data may be obtained in real time. The deviation in the first set of data and the second set of data may be used to identify one or more issues associated with the digital facility. The one or more issues may include high severity issues and not caught issues. The deviation may be determined in real time. The key responsibility area may be defined based on the status of the one or more tasks.

### BRIEF DESCRIPTION OF FIGURES

Having thus described the aspects of the disclosed embodiments in general terms, reference will now be made to the accompanying drawings, which are not necessarily drawn to scale, and wherein:

FIG. 1 illustrates a block diagram of a digital facility, in accordance with an embodiment of the present disclosure;

FIG. 2 illustrates an interactive computing environment for enabling real-time audit of the digital facility, in accordance with various embodiments of the present disclosure;

FIG. 3A and FIG. 3B illustrate a flowchart for a method to conduct audit for controlling quality of the digital facility based on feedback collected from a plurality of sources, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present invention. These figures are not intended to limit the scope of the present invention. It should also be noted that accompanying figures are not necessarily drawn to scale.

### DETAILED DESCRIPTION

Reference will now be made in detail to selected embodiments of the present disclosure in conjunction with accompanying figures. The embodiments described herein are not intended to limit the scope of the present, and the present disclosure should not be construed as limited to the embodiments described. This present disclosure may be embodied in different forms without departing from the scope and spirit of the present disclosure. It should be understood that the accompanying figures are intended and provided to illustrate embodiments of the present disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

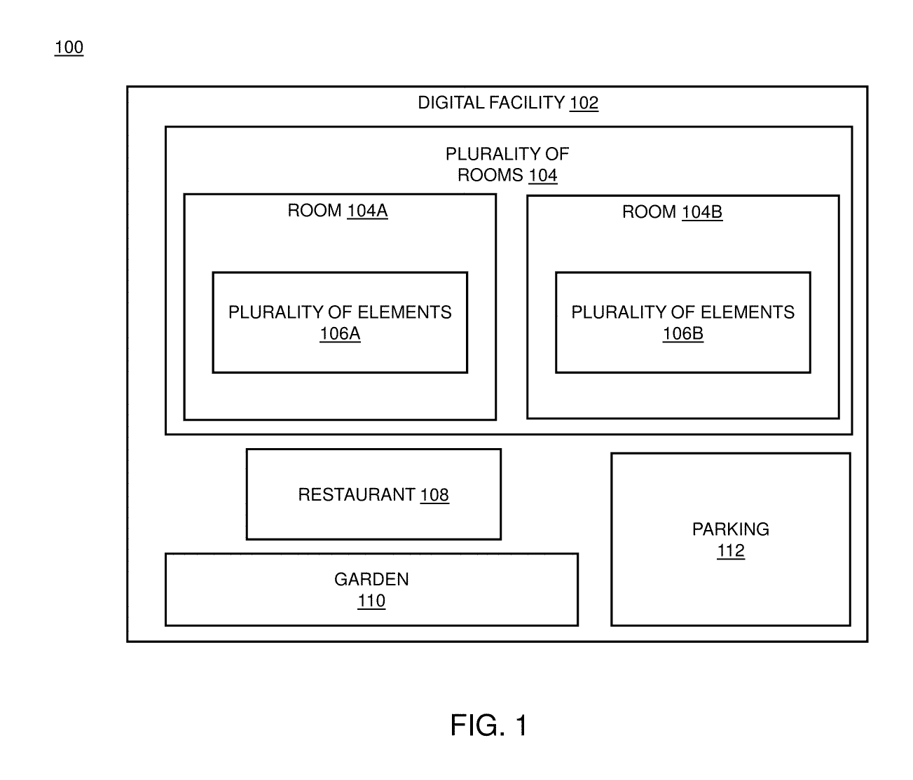

FIG. 1 illustrates a block diagram 100 of a digital facility 102, in accordance with an embodiment of the present disclosure. The digital facility 102 may be any building or place used for a particular purpose. In addition, the digital facility 102 is any place used to provide a particular service. Further, the digital facility 102 is any place used for a particular industry. In an example, the digital facility 102 may be any production unit used for the production of one or more products. In another example, the digital facility 102 may be any health care unit used for health care purposes. In yet another example, the digital facility 102 may be any educational unit used for the educational purposes. In yet another example, the digital facility 102 may be any food unit used for the food-related services. In yet another example, the digital facility 102 may be any commercial and residential unit used for residence purposes. In an example, the digital facility 102 includes but may not be limited to hotels, restaurants, shopping malls, schools, colleges, motels, rooms, libraries and the like.

The digital facility 102 includes a plurality of regions which specifies the area of the digital facility 102. In an example, the plurality of regions includes but may not be limited to a plurality of rooms 104, restaurant 108, garden area 110 and parking area 112. In addition, the plurality of rooms 104 includes a room 104a and a room 104b. In an example, the plurality of rooms 104 includes but may not be limited to a hotel room, kids room, meeting room, dining room, staff room, classroom, activity room, changing room, store room, and the like. Further, the room 104a includes a plurality of elements 106a and the room 104b includes a plurality of elements 106b. Moreover, the plurality of elements 106a-106b includes but may not be limited to bed, table, chair, Air conditioner, television, window, doors, furniture, refrigerator, bed sheet, lights, fan, paintings and the like. In an example, the plurality of rooms 104 may include washroom area, balcony area and bed area as the regions of each room of the plurality of rooms 104. The plurality of regions combines to form the digital facility 102.

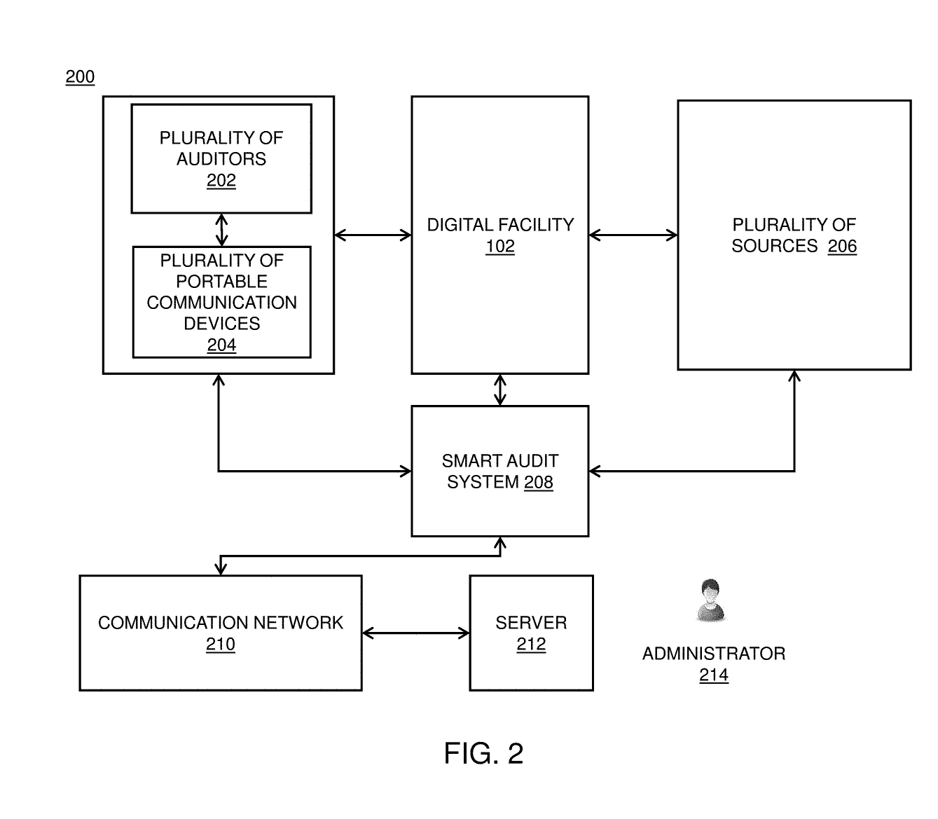

FIG. 2 illustrates a block diagram 200 of an interactive computing environment for enabling the audit of the digital facility 102 in real time, in accordance with various embodiments of the present disclosure. The audit is done to control and maintain the quality of the digital facility 102. The block diagram 200 includes the digital facility 102, a plurality of auditors 202, a plurality of portable communication devices 204 and a plurality of sources 206. In addition, the block diagram 200 includes a smart audit system 208, a communication network 210, a server 212 and an administrator 214.

In an embodiment of the present disclosure, the digital facility 102 is any building or place used for the particular purpose. In addition, the digital facility 102 is any place used to provide the particular service. Further, the digital facility 102 is any place used for the particular industry. In an example, the digital facility 102 includes but may not be limited to hotels, restaurants, shopping malls, schools, colleges, motels, rooms, libraries and the like. In an embodiment of the present disclosure, the digital facility 102 is audited by the plurality of auditors 202 to control and maintain a plurality of quality parameters associated with the digital facility 102.

In an embodiment of the present disclosure, the plurality of auditors 202 includes person or individual for conducting an audit of the digital facility 102. In addition, the plurality of auditors 202 conduct audits within the digital facility 102. In an example, the digital facility 102 is any hotel and the plurality of auditors 202 is assigned to audit the rooms located inside the hotel. Further, the plurality of auditors 202 is associated with the plurality of portable communication devices 204. The plurality of portable communication devices 204 is used to receive or transfer the audit-related information from one place to another place. Each of the plurality of auditors 202 has one or more portable communication device.

In an embodiment of the present disclosure, the plurality of portable communication devices 204 facilitates the exchange of audit-related information from one device to another device. In addition, the plurality of portable communication devices 204 is used to store the audit-related information for the plurality of auditors 202. Further, the plurality of auditors 202 is associated with the plurality of portable communication devices 204. In an example, the plurality of portable communication devices 204 includes but may not be limited to a smartphone, a tablet, a laptop and an electronic wearable device. In an example, each of the plurality of auditors 202 accesses the portable communication device in real time. Further, the plurality of communication devices 204 includes an application installed on the portable communication device. In an example, the plurality of the portable communication devices 204 is utilized for viewing audit-related information. The audit-related information is accessible through the application dedicated for the audit of the digital facility 102. The plurality of portable communication devices 204 is connected to the internet in real time. Further, the plurality of portable communication devices 204 is associated with a specific type of operating system. The specific type of operating system includes but may not be limited to an Android operating system, a Windows operating system, a mac operating system and the like. Furthermore, the plurality of portable communication devices 204 may be connected to the internet through a Wi-Fi.

In an embodiment of the present disclosure, the plurality of auditors 202 conduct audit based on the data received from the plurality of sources 206. The plurality of sources 206 is the place to get the data for the audit of the digital facility 102. In an embodiment of the present disclosure, the plurality of sources 206 may include one or more communication devices, one or more visitors of the digital facility 102, one or more manpower associated with the digital facility 102. In addition, the plurality of sources 206 may include one or more secret auditors and one or more quality assurance managers. Further, the plurality of sources 206 may include one or more sensors, a plurality of micro descriptors and the like.

In an example, the one or more visitors may be the person or individuals who have a stay at the digital facility 102 for a specific period of time. The one or more visitors may provide a set of data related to their stay at the digital facility 102. The set of data may correspond to the satisfaction of the one or more visitors who visit the digital facility 102 for the specific period of time. In addition, the set of data may represent the quality of the digital facility 102. Further, the set of data may be in the form of feedback of the digital facility 102 provided by the one or more visitors. The one or more visitors may provide the feedback through the communication device. In an example, the communication device may be a tablet, laptop and a smartphone located within the facility 102 for providing feedback. Further, the feedback is provided in an application installed in the communication device. The application is associated with the management of the digital facility 102. In an embodiment of the present disclosure, the one or more communication devices used for the feedback may be owned by the manpower associated with the digital facility 102. The manpower corresponds to the person or individual associated with the digital facility 102. In an example, the manpower includes staff members of the digital facility 102 and owner of the digital facility 102. In another embodiment of the present disclosure, the one or more visitors may be the owner of the one or more communication devices used to provide feedback of the digital facility 102. The one or more visitors may provide the feedback to the digital facility 102 in the form of rating, comments, and reviews.

In an example, the plurality of sources 206 includes the one or more secret auditors. The one or more secret auditors conduct a random audit of the digital facility 102. In an embodiment of the present disclosure, the one or more secret auditors are the persons or individuals assigned with the task of secretly conducting the audit of the digital facility 102. The one or more secret auditors correspond to the persons who are not the member of the digital facility 102. The one or more secret auditors stay at the digital facility 102 and audit the plurality of regions of the digital facility 102. After the stay at the digital facility 102 the secret auditor provides his feedback on the quality of the digital facility 102.

In an embodiment, the plurality of sources 206 includes the one or more sensors associated with the digital facility 102. The one or more sensors are fixed to collect the data of one or more specific region of the plurality of regions. In an example, the one or more sensors are fixed around the air conditioner, around the water tap, around the lightning and the like to collect the feedback data. In an embodiment of the present disclosure, the one or more sensors are based on the internet of things.

In an embodiment of the present disclosure, the digital facility 102 is associated with the smart audit system 208 to control the quality of audit of the digital facility 102. In addition, the smart audit system 208 facilitates in maintaining the quality of the digital facility 102. The smart audit system 208 collects a first set of data. The first set of data is associated with the feedback of the digital facility 102. In addition, the feedback of the digital facility 102 is collected from the plurality of sources 206. In an embodiment, the feedback of the digital facility 102 is collected in real time. In another embodiment, the feedback of the digital facility 102 may not be collected in real time. Further, the feedback of the digital facility 102 is collected based on a plurality of micro descriptors. The plurality of micro descriptors is associated with a plurality of regions of the digital facility 102. The plurality of regions within the digital facility 102 specifies the area of the digital facility 102. In an example, the plurality of regions may include multiple rooms, common area, parking area, garden area, restaurant and the like, when the digital facility 102 corresponds to any hotel. In another example, the plurality of regions may include specific area inside the room, kitchen, restaurant, parking and the like. Moreover, the plurality of micro descriptors facilitates to provide the feedback of each region of the plurality of regions of the digital facility 102. In an example, the first set of data includes reviews, comments, and ratings provided to the digital facility 102 by the plurality of sources 206. In another example, the first set of data may be the data used to maintain and control the quality of the digital facility 102. Also, the plurality of micro descriptors is the points on which the feedback is provided by the plurality of sources 206. In an embodiment of the present disclosure, the plurality of micro descriptors allot for each region of the plurality of regions is based on a plurality of levels. The plurality of levels is the levels of digital facility 102 define to ease the collection of feedback by the plurality of source. In an example, the plurality of level includes a first level, a second level, and a third level. The first level represents the one or more large regions. In an example, the first level includes room, restaurant, common area and the like. The second level represents the one or more regions come under the category of the first level. In an example, the second level includes windows, bed, furniture, bathroom and the like. The third level represents the one or more regions come under the category of the second level. In an example, the third level includes linen condition, curtain conditions, pillow condition and the like. In an example, the plurality of micro descriptors assigned for the plurality of levels includes but may not be limited to linen, walls, noise level, lighting, TV, AC, Refrigerator, mirror, table, shower, towel, Wi-Fi signal and the like.

In an example, the digital facility 102 is a Hotel X. The visitor Y stays in the room A1 of the hotel X for one night. The visitor Y observes one or more problems in the room A1 of the hotel X. The one or more problems include wrinkles on linen, crack in the furniture and dirty curtains. The feedback of the room is collected from the visitor Y at the reception when the visitor Y checkout from the hotel X. The feedback is taken in a tablet having an installed application G and internet connection. The installed application G is used to collect the feedback of the hotel X from the visitors during their stay at hotel X. The visitor Y clicks on one or more points from the list in the tablet which include the one or more problems faced by the visitor during the stay. The list mentions all the possible problems that the visitor may face during the stay.

In the above example, the digital facility 102 is the hotel X. In addition, the plurality of sources 206 from which the feedback is collected includes the visitor Y. The one or more communication devices used to collect feedback is the Tablet. The plurality of micro descriptors is the list of all possible problems associated with the digital facility 102.

The smart audit system 208 creates one or more tasks based on the first set of data. The one or more tasks are created for the audit of the digital facility 102. In addition, the one or more tasks are created to maintain the quality of the digital facility 102. The one or more tasks are created to resolve the problems faced by the visitors during their stay at the digital facility 102. The one or more tasks are created for the plurality of auditors 202 to audit the digital facility 102. In addition, the one or more tasks are created to reduce the time of audit of the digital facility 102. Further, the one or more tasks are created based on the optimized feedback collected from the plurality of sources 206. The one or more tasks are the tasks given to the plurality of auditors 202 for the audit of the digital facility 102. In an example, the one or more tasks created are manually based on the demand. In another example, the one or more tasks created are intelligent tasks. The intelligent tasks are assigned to the plurality of auditors 202 on daily basis, after a particular interval of time, for a specific region and the like.

The smart audit system 208 receives the second set of data associated with the plurality of auditors 202. The second set of data corresponds to the data of the plurality of auditors 202 available to audit the digital facility 102. In an example, the second set of data includes but may not be limited to a profile of each auditor of the plurality of auditors 202, the experience of the each auditor of the plurality of auditors 202. In addition, the second set of data includes demographic information of each auditor of the plurality of auditors 202. The demographic information includes name, age, address, contact details, qualification and the like of each auditor of the plurality of auditors 202. In addition, the smart audit system 208 may receive the second set of data to assign the suitable auditor of the plurality of auditors 202 for the one or more tasks. Further, the smart audit system 208 may receive the second set of data to assign the suitable auditor based on the one or more tasks.

The smart audit system 208 analyzes the first set of data and the second set of data. The analyzing of the first set of data and the second set of data is done to identify the competent auditor for the one or more tasks. In an example, the analyzing of the first set of data and the second set of data is done using machine learning algorithms. In addition, the analyzing is done to map the first set of data and the second set of data for assigning the competent auditor of the plurality of auditors 202 for one or more tasks. In an embodiment of the present disclosure, the analyzing is done in real time. In another embodiment of the present disclosure, the analyzing may not be done in real time.

The smart audit system 208 assigns the one or more tasks to each of the plurality of auditors 202 for the audit of the digital facility 102. The assigning of the one or more tasks is based on the analyzing of the first set of data and the second set of data. The assigning of the one or more tasks to the competent auditor is done to enhance the quality of audit for certain one or more tasks.

In an example, the smart audit system 208 receives data of four auditors available near the location of the hotel H. The data includes name, address, contact details and qualification related information. The smart audit system 208 analyzes the data of the four auditors and the data associated with the hotel H to assign suitable auditor of the four auditors for the audit of the hotel H. The analyzing is based on one or more parameters. The one or more parameters include the nearest auditor to the hotel H, one or vehicle corresponds to the auditor to reach hotel H, experience in auditing and the like.

In an embodiment of the present disclosure, the one or more tasks assigned to the auditor get activated when the portable communication device associated with the auditor is in the radius of the digital facility 102. In an example, the radius of the digital facility 102 defines a specific range near the digital facility 102. The smart audit system 102 determines the duration of the audit of the digital facility 102 from the activation time to the completion time of the one or more tasks. The smart audit system 208 obtains a third set of data from the plurality of auditors 202. The third set of data is associated with the audit of the digital facility 102. In an example, the third set of data is obtained in real time. The third set of data includes information related to the audit of the digital facility 102. In an example, the third set of data includes starting time and completion time of the audit of the one or more tasks, the status of the one or more tasks and the like.

The smart audit system 208 determines the deviation in the first set of data and the second set of data. In an example, the deviation in the first set of data and the second set of data is determined using machine learning algorithms. In addition, the deviation in the first set of data and the second set of data is used to identify one or more issues associated with the digital facility 102. Further, the one or more identified issues include high severity issues and not caught issues. The high severity issues associated with the digital facility 102 results in preventing booking of the particular region of the digital facility 102. The particular region In an example, when the digital facility 102 is a hotel, the cause of high severity issues include but may not be limited to the absence of towel, Wi-Fi speed problem, the problem in working of Air Conditioner inside the room. In an example, the high severity issue is defined when the number of issues associated with the digital facility crosses a predefined level. The predefined level is based on the number of critical issues, status of the one or more issues and the like. Further, the issue not caught is identified based on the one or more parameters. In an example, the one or more parameters include task completion time and quality of audit. In addition, the issue not caught is a measure of the one or more issues which were not detected by the plurality of auditors 202 during audit while detected by the plurality of sources 206. In an example, a visitor X provides feedback mentioning the issue in the working of Geyser. The issue in the working of Geyser comes under the issue not caught when the auditor Y is unable to detect the issue in the working of Geyser during the audit. In addition, the issue not caught affects the key responsibility area of the specific auditor of the plurality of auditors 202.

The smart audit system 208 provides a rating to the plurality of auditors 202. The rating is based on the key responsibility area of each auditor of the plurality of auditors 202. The key responsibility area may include efficiency of the auditing, duration of auditing, the accuracy of audit and the like. In addition, the rating is provided to the plurality of auditors 202 based on the status of the one or more tasks performed by the plurality of auditors 202. In an example, the rating is given to the plurality of auditors 202 for providing incentives.

In an embodiment of the present disclosure, the smart audit system 208 predicts the one or more issues associated with the digital facility 102 using the past data and the real-time data. In an example, the one or more issues are predicted based on the machine learning algorithms. In addition, the smart audit system 208 predicts the time to resolve the one or more issues based on the severity of the issue. In addition, the smart audit system 208 schedules the one or more tasks for a future audit of the digital facility 102. The scheduling of the one or more tasks is based on the one or more parameters. In an example, the one or more parameters include last inspection data, time required to resolve one or more issues, date and time of last audit and the like. Further, the smart audit system 208 alerts the plurality of auditors 202 about the upcoming task by sending one or more notification on the portable communication device access by the plurality of auditors 202. In an example, the smart audit system 208 sends a message on the portable communication device of the plurality of auditors 202 mentioning the details of the upcoming one or more tasks. In an embodiment of the present disclosure, the smart audit system 208 arranges the one or more quick audit of the digital facility 102. In an example, the quick audit may be done before the check-in of the one or more visitors in the digital facility 102. In an example, the quick audit may be done by the plurality of auditors 202. In another example, the quick audit may be done by the one or more manpower available inside the digital facility 102.

In an embodiment of the present disclosure, the smart audit system 208 assigns the one or more tasks to the plurality of auditors 202 to audit a fixed percentage of regions of the plurality of regions within a specific time. In addition, the fixed percentage of regions is based on the third set of data having details of the last audit. Further, the smart audit system 208 allows the swiping of a particular region with another region, when the particular or recommended region is not ready to use or have any severity issue. In an example, the room chooses by the visitor during online booking is not ready or include one or more severity issues, the smart audit system 208 may perform swiping of the room with another room. Moreover, the smart audit system 208 may conduct the audit of the digital facility 102 on a regular basis. The audit of the digital facility 102 may be periodic or specific to regions or may depend upon the last audit data.

In an embodiment of the present disclosure, the smart audit system 208 creates the quality specific matrix based on the first set of data. The quality specific matrix includes but may not be limited to the quality of standards that need to be kept in order to maintain the quality of the digital facility 102 to meet visitor satisfaction. The quality specific matrix assists in identifying issues that are below the pre-defined quality standards.

In an embodiment of the present disclosure, the smart audit system 208 stores the first set of data, the second set of data and the third set of data in real time. In an example, the smart audit system 208 stores data associated with the feedback, data associated with the plurality of auditors 202 and the data associated with the audit.

In an embodiment of the present disclosure, the smart audit system 208 updates the first set of data, the second set of data and the third set of data in real time. In an example, the smart audit system 208 updates data associated with the feedback, data associated with the plurality of auditors 202 and the data associated with the audit.

The smart audit system 208 is associated with the server 212 through the communication network 210. In an embodiment of the present disclosure, the communication network 210 enables the smart audit system 208 to gain access to the internet for transmitting data to the server 212. Moreover, the communication network 210 provides a medium to transfer the data between the smart audit system 208 and the server 212. Further, the medium for communication may be infrared, microwave, radio frequency (RF) and the like.

In an embodiment of the present disclosure, the smart audit system 208 is located in the server 212. In another embodiment of the present disclosure, the smart audit system 208 is located in any portable communication device. The server 212 handles each operation and task performed by the smart audit system 208. The server 212 stores one or more instructions for performing the various operations of the smart audit system 208. The smart audit system 208 is associated with the administrator 214. The administrator 214 is any person or individual who monitors the working of the smart audit system 208 in real time. In an embodiment of the present disclosure, the administrator 214 monitors the working of the smart audit system 208 through a portable communication device. The portable communication device includes a laptop, a desktop computer, a tablet, a personal digital assistant and the like.

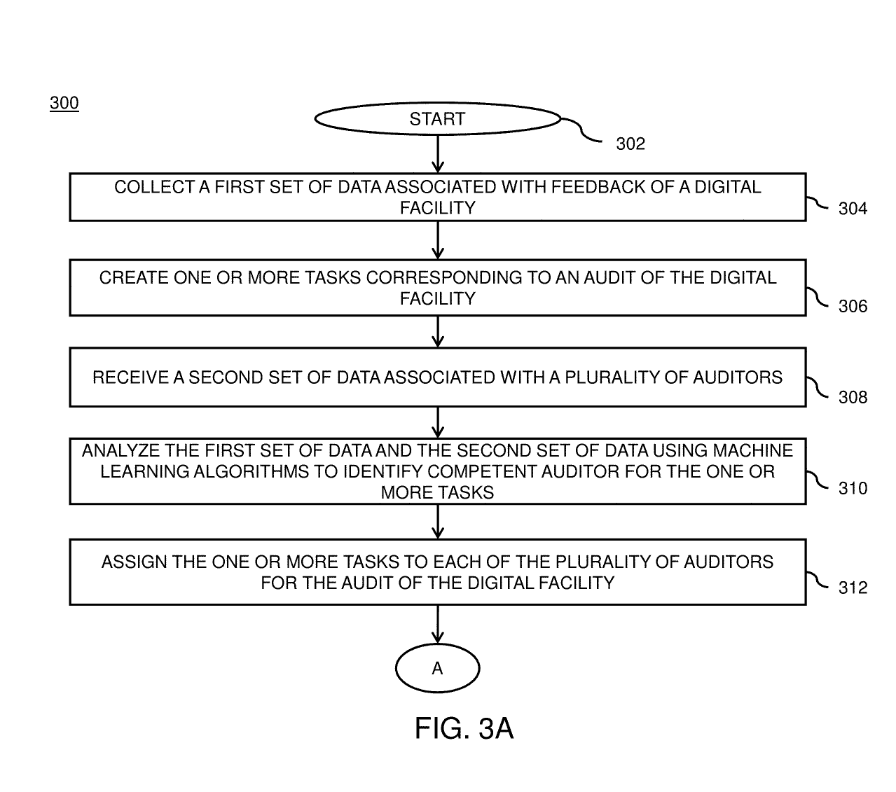

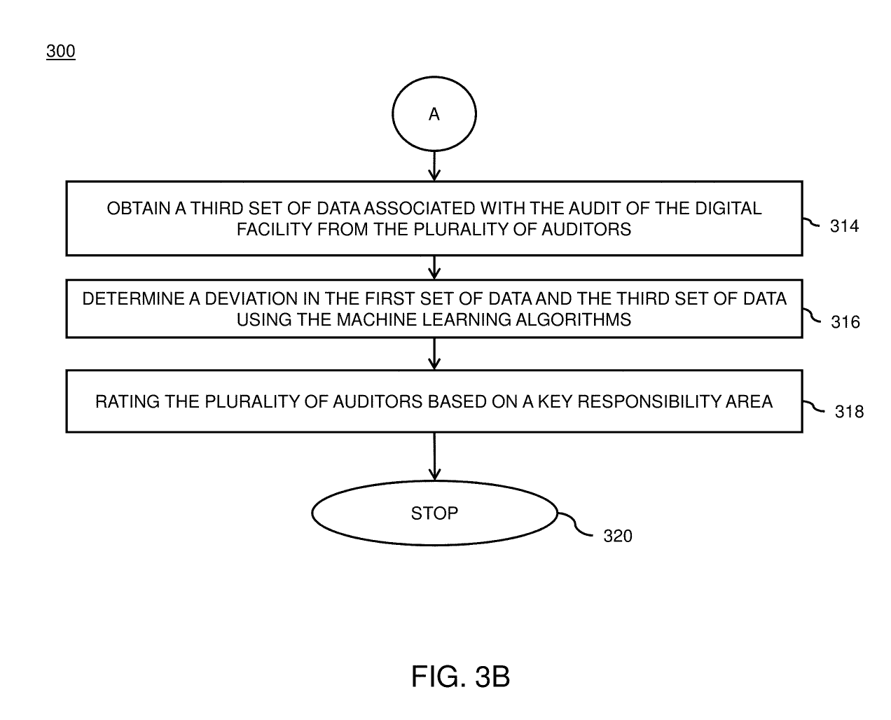

FIG. 3A and FIG. 3B illustrate a flowchart 300 for a method to conduct the audit for controlling the quality of the digital facility 102 based on feedback collected from the plurality of sources, in accordance with various embodiments of the present disclosure. It may be noted that to explain the process steps of the flowchart 300, references will be made to the system elements of FIG. 1 and FIG. 2. It may be noted that the flowchart 300 may have lesser or more number of steps.

The flowchart 300 initiates at step 302. Following step 302, at step 304, the smart audit system 208 collects the first set of data. The first set of data is associated with the feedback of the digital facility 102. In addition, the feedback of the digital facility 102 is collected from the plurality of sources 206. At step 306, the smart audit system 208 creates the one or more tasks based on the first set of data. The one or more tasks are created for the audit of the digital facility 102. In addition, the one or more tasks are created to maintain the quality of the digital facility 102. At step 308, the smart audit system 208 receives the second set of data associated with the plurality of auditors 202. The second set of data corresponds to the data of the plurality of auditors 202 available to audit the digital facility 102. At step 310, the smart audit system 208 analyzes the first set of data and the second set of data. The analyzing of the first set of data and the second set of data is done to identify the competent auditor for the one or more tasks. At step 312, the smart audit system 208 assigns the one or more tasks to each of the plurality of auditors 202 for the audit of the digital facility 102. The assigning of the one or more tasks is based on the analyzing of the first set of data and the second set of data. At step 314, the smart audit system 208 obtains the third set of data from the plurality of auditors 202. The third set of data is associated with the audit of the digital facility 102. At step 316, the smart audit system 208 determines the deviation in the first set of data and the second set of data. In addition, the deviation in the first set of data and the second set of data is used to identify one or more issues associated with the digital facility 102. At step 318, the smart audit system 208 provides the rating to the plurality of auditors 202. The rating is based on the key responsibility area of each auditor of the plurality of auditors 202. The key responsibility area may include efficiency of the auditing, duration of auditing, the accuracy of audit and the like. In addition, the rating is provided to the plurality of auditors 202 based on the status of the one or more tasks performed by the plurality of auditors 202. The flow chart 300 terminates at step 320.

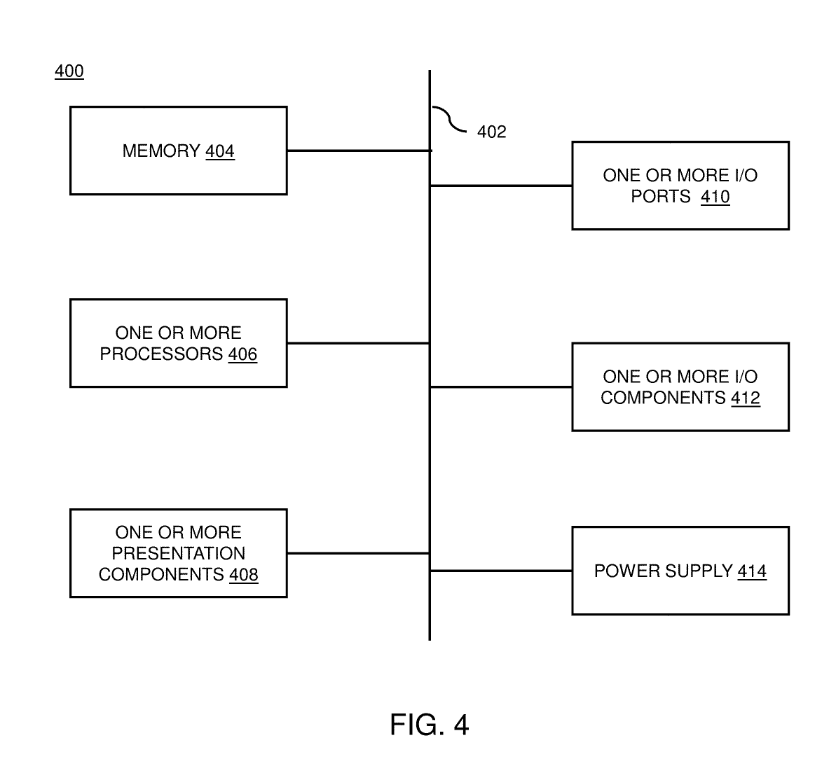

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for sake of clarity, in reality, delineating various components is not so clear, and metaphorically, the lines would more accurately be grey and fuzzy. For example, one may consider a presentation component such as a display device to be an I/O component. Also, processors have memory. FIG. 4 is merely illustrative of an exemplary computing device 400 may be used in connection with one or more embodiments of the present disclosure. Distinction is not made between such categories as workstation, server, laptop, hand-held device and the like, as all are contemplated within the scope of FIG. 4 and reference to “the computing device 400.”

The computing device 400 typically includes a computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes the volatile and the nonvolatile, the removable and the non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies the computer-readable instructions, the data structures, the program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, the communication media includes wired media such as a wired network or direct-wired connection, and wireless media such as acoustic, RF, infrared and other wireless media. Combinations of any of the above should also be included within the scope of the computer readable media.

Memory 404 includes the computer-storage media in the form of volatile and/or nonvolatile memory. The memory 404 may be removable, non-removable, or a combination thereof. Exemplary hardware devices include solid-state memory, hard drives, optical-disc drives and the like. The computing device 400 includes the one or more processors to read data from various entities such as memory 404 or I/O components 412. The one or more presentation components 408 present data indications to a user or other device. Exemplary presentation components include a display device, speaker, printing component, vibrating component and the like. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device and the like.

What is claimed is:

1. A computer-implemented method to conduct audit for controlling quality of a digital facility based on a feedback collected from a plurality of sources, the computer-implemented method comprising:
collecting, at a smart audit system with a processor, a first set of data associated with the feedback of the digital facility, wherein the feedback of the digital facility being collected based on a plurality of micro descriptors associated with one or more regions of the digital facility and wherein the first set of data being collected from the plurality of sources in real time;
creating, at the smart audit system with the processor, one or more tasks corresponding to an audit of the digital facility, wherein the one or more tasks being created based on the first set of data in real time;
receiving, at the smart audit system with the processor, a second set of data associated with a plurality of auditors, wherein the plurality of auditors conduct the audit of the digital facility based on the first set of data and wherein the second set of data being received in real time;
analyzing, at the smart audit system with the processor, the first set of data and the second set of data using machine learning algorithms to identify a competent auditor for the one or more tasks, wherein the first set of data and the second set of data being analyzed in real time;
assigning, at the smart audit system with the processor, the one or more tasks to each of the plurality of auditors for the audit of the digital facility, wherein the one or more tasks being assigned based on the analyzing of the first set of data and the second set of data and wherein the one or more tasks being assigned in real time;
obtaining, at the smart audit system with the processor, a third set of data associated with the audit of the digital facility from the plurality of auditors, wherein the third set of data being obtained in real time;
determining, at the smart audit system with the processor, a deviation in the first set of data and the third set of data using the machine learning algorithms, wherein the deviation in the first set of data and the second set of data being used to identify one or more issues associated with the digital facility, wherein the one or more issues comprises high severity issues and not caught issues and wherein the deviation being determined in real time; and
rating, at the smart audit system with the processor, the plurality of auditors based on a key responsibility area and wherein the key responsibility area for the plurality of auditors being defined based on a status of the one or more tasks.

2. The computer-implemented method as recited in claim 1, further comprising predicting, at the smart audit system with the processor, the one or more issues associated with the digital facility and time to resolve the one or more issues using the machine learning algorithms, wherein the machine learning algorithms being based on a past stored data and a real-time data of the digital facility.

3. The computer-implemented method as recited in claim 1, further comprising storing, at the smart audit system with the processor, the first set of data, the second set of data and the third set of data, wherein the storing being done in real time.

4. The computer-implemented method as recited in claim 1, further comprising updating, at the smart audit system with the processor, the first set of data, the second set of data and the third set of data, wherein the updating being done in real time.

5. The computer-implemented method as recited in claim 1, wherein the plurality of sources comprises quality assurance managers, visitors, feedback calls, secret auditor, feedback tab, crowdsource, manpower associated with the digital facility and one or more sensors associated with the digital facility.

6. The computer-implemented method as recited in claim 1, wherein the issue not caught being identified based on one or more parameters, wherein the one or more parameters comprises completion time of the one or more tasks, the status of the one or more tasks and quality of the audit.

7. The computer-implemented method as recited in claim 1, wherein the second set of data comprises a profile of each auditor of the plurality of auditors, experience of each auditor in audit field and a demographic information of each auditor of the plurality of auditors.

8. The computer-implemented method as recited in claim 1, further comprising scheduling, at the smart audit system with the processor, the one or more tasks for future audit of the digital facility, wherein the scheduling of the one or more tasks being based on one or more parameters, wherein the one or more parameters comprises last audit data, the one or more issues, date and time of the last audit.

9. The computer-implemented method as recited in claim 1, further comprising alerting, at the smart audit system with the processor, the plurality of auditors for the upcoming task and one or more unsolved issues.

10. The computer-implemented method as recited in claim 1, further comprising arranging, at the smart audit system with the processor, a quick inspection of the digital facility being allocated to a guest, wherein the quick inspection being arranged based on check-in date and time of the guest.

11. A computer system comprising:
one or more processor; and
a memory coupled to the one or more processors, the memory for storing instructions which, when executed by the one or more processors, cause the one or more processors to perform a method to conduct audit for controlling quality of a digital facility based on a feedback collected from a plurality of sources, the method comprising:
collecting, at a smart audit system, a first set of data associated with the feedback of the digital facility, wherein the feedback of the digital facility being collected based on a plurality of micro descriptors associated with one or more regions of the digital facility and wherein the first set of data being collected from the plurality of sources in real time;
creating, at the smart audit system, one or more tasks corresponding to an audit of the digital facility, wherein the one or more tasks being created based on the first set of data in real time;
receiving, at the smart audit system, a second set of data associated with a plurality of auditors, wherein the plurality of auditors conduct the audit of the digital facility based on the first set of data and wherein the second set of data being received in real time;
analyzing, at the smart audit system, the first set of data and the second set of data using machine learning algorithms to identify a competent auditor for the one or more tasks, wherein the first set of data and the second set of data being analyzed in real time;
assigning, at the smart audit system, the one or more tasks to each of the plurality of auditors for the audit of the digital facility, wherein the one or more tasks being assigned based on the analyzing of the first set of data and the second set of data and wherein the one or more tasks being assigned in real time;
obtaining, at the smart audit system, a third set of data associated with the audit of the digital facility from the plurality of auditors, wherein the third set of data being obtained in real time;
determining, at the smart audit system, the deviation in the first set of data and the third set of data using the machine learning algorithms, wherein a deviation in the first set of data and the second set of data being used to identify one or more issues associated with the digital facility, wherein the one or more issues comprises high severity issues and not caught issues and wherein the deviation being determined in real time; and
rating, at the smart audit system, the plurality of auditors based on a key responsibility area and wherein the key responsibility area for the plurality of auditors being defined based on a status of the one or more tasks.

12. The computer system as recited in claim 11, further comprising predicting, at the smart audit system, the one or more issues associated with the digital facility and time to resolve the one or more issues using the machine learning algorithms, wherein the machine learning algorithms being based on a past stored data and a real-time data of the digital facility.

13. The computer system as recited in claim 11, further comprising storing, at the smart audit system, the first set of data, the second set of data and the third set of data, wherein the storing being done in real time.

14. The computer system as recited in claim 11, wherein the plurality of sources comprises quality assurance managers, visitors, feedback calls, secret auditor, feedback tab, crowdsource, manpower associated with the digital facility and one or more sensors associated with the digital facility.

15. The computer system as recited in claim 11, wherein the issue not caught being identified based on the one or more parameters, wherein the one or more parameters comprises completion time of the one or more tasks, the status of the one or more tasks and quality of the audit.

16. The computer system as recited in claim 11, wherein the second set of data comprises a profile of each auditor of the plurality of auditors, an experience of each auditor in audit field and a demographic information of each auditor of the plurality of auditors.

17. The computer system as recited in claim 11, further comprising scheduling, at the smart audit system, the one or more tasks for future audit of the digital facility, wherein the scheduling of the one or more tasks being based on one or more parameters, wherein the one or more parameters comprises last audit data, the one or more issues, date and time of the last audit.

18. The computer system as recited in claim 11, further comprising alerting, at the smart audit system, the plurality of auditors for the upcoming task and one or more unsolved issues.

19. The computer system as recited in claim 1, further comprising arranging, at the smart audit system, a quick inspection of the digital facility being allocated to a guest, wherein the quick inspection being arranged based on check-in date and time of the guest.

20. A computer-readable storage medium encoding computer executable instructions that, when executed by at least one processor, performs a method to conduct audit for controlling quality of a digital facility based on a feedback collected from a plurality of sources, the method comprising:
collecting, at a computing device, a first set of data associated with the feedback of the digital facility, wherein the feedback of the digital facility being collected based on a plurality of micro descriptors associated with one or more regions of the digital facility and wherein the first set of data being collected from the plurality of sources in real time;
creating, at the computing device, one or more tasks corresponding to an audit of the digital facility, wherein the one or more tasks being created based on the first set of data in real time;
receiving, at the computing device, a second set of data associated with a plurality of auditors, wherein the plurality of auditors conduct the audit of the digital facility based on the first set of data and wherein the second set of data being received in real time;
analyzing, at the computing device, the first set of data and the second set of data using machine learning algorithms to identify a competent auditor for the one or more tasks, wherein the first set of data and the second set of data being analyzed in real time;
assigning, at the computing device, the one or more tasks to each of the plurality of auditors for the audit of the digital facility, wherein the one or more tasks being assigned based on the analyzing of the first set of data and the second set of data and wherein the one or more tasks being assigned in real time;
obtaining, at the computing device, a third set of data associated with the audit of the digital facility from the plurality of auditors, wherein the third set of data being obtained in real time;
determining, at the computing device, a deviation in the first set of data and the third set of data using the machine learning algorithms, wherein the deviation in the first set of data and the second set of data being used to identify one or more issues associated with the digital facility, wherein the one or more issues comprises high severity issues and not caught issues and wherein the deviation being determined in real time; and
rating, at the computing device, the plurality of auditors based on a key responsibility area and wherein the key responsibility area for the plurality of auditors being defined based on a status of the one or more tasks.
